(19) United States
(12) Patent Application Publication
(10) Pub. No.: US 2010/0229866 A1
(43) Pub. Date: Sep. 16, 2010

(54) GAS MASK ASSEMBLY WITH SWIVEL CONNECTOR

(75) Inventor: Colin Sullivan, Balmain (AU)

Correspondence Address: LANDO & ANASTASI, LLP, ONE MAIN STREET, SUITE 1100, CAMBRIDGE, MA, 02142, US

(73) Assignee: Austrlian Centre for Advanced Medical Tecnology Pty Ltd, Balmain NSW (AU)

(21) Appl. No.: 12/444,818

(22) PCT Filed: Oct. 9, 2007
(86) PCT No.: PCT/AU2007/001521

§ 371 Date: Jun. 1, 2010

(30) Foreign Application Priority Data
Oct. 9, 2006 (AU) 2006905587

(51) Int. Cl. A62B 18/08

(52) U.S. Cl. 128/205.25

(57) ABSTRACT

A connection assembly for joining a gas supply line to an article, the assembly comprising a first member having first and second ends, inner and outer walls; and a through passage between said ends; a second member having first and second ends, the second end engagable with the first member via the first end of the first member, the second end of the first member connectable to the article and the first end of the second member connectabte to a gas line; wherein the connection between the first and second members is arranged to allow relative movement between the first and second members such that either of the first and second members are each able to rotate axially relative to the other member through a 360 degrees arc about longitudinal axes through each member and to each move relative to the other member between a first disposition where the longitudinal axes of the first and second members are in alignment and at least one second disposition where at least the second member is disposed at an angle to the longitudinal axis of the first member.

### FIELD OF THE INVENTION

This invention relates to connectors for attachment of gas supply lines to gas mask assemblies and in particular, to masks for supplying gases, typically air or oxygen, to the airways (nose and/or mouth) of humans. Such masks are often referred to as “respirator masks” and are particularly suited to applying continuous positive airway pressure (CPA) to patients for a variety of treatments. More particularly, the invention relates to gas supply line connection arrangements for a mask assembly which includes a manifold section having a face contacting part and an inlet connecting to the manifold and a gas supply line connected to the inlet. The invention provides at least one swivel joint connector in a gas supply line to such mask assemblies and which allows 360 degree axial rotation of a line relative to a mask about a longitudinal axis through the supply line and swivel movement of the line relative to the mask at an angle to the longitudinal axis of the supply line thereby providing wide degrees of freedom.

### BACKGROUND OF THE INVENTION

In general, conventional respirator masks consist of a face contacting part which defines an orifice and which fits over the patient's nose and/or mouth and provides a gas tight seal against the patient's skin. The reverse side of the orifice is enclosed by a manifold part for the delivery of pressurized gases to the patient's nose and/or mouth via a gas delivery tube connected to the manifold.

Gas masks have evolved into two broad categories namely those that are of rigid construction and more recently those that are more flexible including a flexible manifold and which have the ability to deform to accommodate movement and facial contours during such movement with out compromising the required gas seal.

Typically, in the first category of masks, the manifold part is made from a rigid material to which is attached an adjustable harness, for retaining the mask on a patient's head. A face contacting part is compressed against the patient's face causing a gas tight seal to form between the face contacting part and the patient's face.

Typically, the face contacting part of a conventional respirator mask is made from a soft flexible material such as silicone rubber which distorts in response to distortion in a Z plane.

Considerable work has been undertaken on the geometry of and materials used in these gas masks in an attempt to prevent the effects of movements which break the gas seal during use. This might occur when a patient turns over or is turned over such as in the case of a baby. These movements have in the past moved rigid masks to a point where a seal is broken and contributing to this is the inflexibility of the connections to the mask manifold.

In one common design of conventional mask, as well as the relatively thicker face contacting part, the mask includes a much thinner face sealing membrane portion attached to the face contacting part. In use, as the face contacting portion is lowered onto a patient's face some areas of the flexible membrane portion will contact some parts of the patient's face before others. These areas are compressed towards the relatively thicker, less flexible, section of the face contacting part. Once in place, at some sections of the interface between the mask and the patient's face, the flexible membrane is compressed tightly against the relatively thicker portion of the face contacting part, whereas at other sections the membrane seals against the face but floats freely of the relatively thicker portion. The flexible membrane provides a gas tight seal between the relatively thicker portion and the patient's face.

When a patient wearing a mask having a rigid manifold turns in bed and contacts an object such as a pillow, reaction forces from the pillow tend to push the manifold laterally and lift the face contacting part from the patient's face thereby breaking the gas tight seal and causing an air leak which prevents optimum therapy being delivered to the patient. Hard plastic components may also cause pain or discomfort if they are pushed hard against a patient's skin during sleep. Contributing to this is the relatively rigid gas line connection and that face that there is either limited degree of freedom usually in only one plane or no freedom of relative movement between the mask and gas line.

The design of many existing masks involves the use of multiple plastic and silicone parts. Some consist of a rigid manifold part attached to a face contacting part, typically made from a flexible material such as silicone. Full-face masks have a face contacting part designed to encompass both a patient's nose and mouth, providing a gas tight seal at the mask/face interface in order to enable successful delivery of pressurised gas.

Essential to each of the known mask assemblies used in medical applications is a gas supply line which delivers gas to the masks manifold from a source of gas. Typically a gas supply line will have a first end which connects directly or indirectly to the source of gas and a second end connected to an inlet to the mask manifold. These connections are currently detachable. Some are moment connections (rigidly fixed) and others allow very limited single plane rotation. At the mask's manifold end, the end of the supply line is typically friction fitted to an inlet to the manifold, via a recess included in a swivel connector. The known swivel connector allows the connector to rotate in a two dimensional plane normal to a Z axis. This allows the line some limited flexibility to move relative to the mask when a wearer of the mask moves. The opposite (first) end is usually rigidly connected to the gas supply manifold.

There is a need to increase the degrees of freedom of gas line connections beyond movement in a two dimensional plane so that the masks position on a users face is not compromised by torsional loads applied by the masks on the line or the line on the mask during use. The present invention seeks to address and attempt to alleviate at least some of the deficiencies of the existing masks described above.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF INVENTION

This invention provides connectors for attachment of gas supply lines to gas mask assemblies and which allows the supply line to move relative to the mask and without placing unwanted load lateral, torsional or otherwise. The invention further provides at least one swivel joint connector in a gas supply line to such mask assemblies and which allows 360 degree axial rotation of a line about a longitudinal axis through the supply line and/or swivel movement of the line relative to the mask and at an angle to that axis and in more than one plane.

In its broadest form, the present invention comprises:

a gas delivery line assembly for delivery of gas to a patient via a face mask having a manifold, a face contacting portion which engages the face of a wearer, means to fasten the mask to a face of a wearer and an inlet which allows delivery of gas from a gas source to the inside of said manifold via said line; characterised in that the delivery line is connected to the manifold via a swivel connector which allows 360 degree axial rotation.

Preferably there is provided a swivel connector at either end of the delivery line.

In another broad form, the present invention comprises:

a gas delivery assembly for delivery of gas to a patient, the assembly including a face mask having a manifold, a face contacting portion which engages the face of a wearer, means to fasten the mask to a face of a wearer and an inlet which allows delivery of gas from a gas source to the inside of said manifold; the assembly further comprising a gas delivery line communicating between the gas source and said manifold; characterised in that the delivery line is connected to the manifold via a swivel connector which allows 360 degree axial rotation of the line about a longitudinal axis through the supply line and/or swivel movement of the line relative to the mask.

According to a preferred embodiment, the assembly has a swivel connector at the mask manifold end and a second like swivel connection at an opposite end of the gas delivery line. Preferably each swivel connector comprises opposite gender inter fitting with a male profile part at least part of which has a curved surface which engages a corresponding curved surface in a female recess. Preferably the female profile part has an end which engages a recess in an inlet to the mask manifold.

In another broad form, the present invention comprises:

a connection assembly for joining a gas supply line to an article, the assembly comprising a first member having first and second ends, inner and outer walls; and a through passage between said ends;

a second member having first and second ends, the second end engagable with the first member via the first end of the first member,

the second end of the first member connectable to the article and the first end of the second member connectable to a gas line;

wherein the connection between the first and second members is arranged to allow relative movement between the first and second members such that either of the first and second members are each able to rotate axially relative to the other member through a 360 degrees arc about longitudinal axes through each member and to each move relative to the other member between a first disposition where the longitudinal axes of the first and second members are in alignment and at least one second disposition where at least the second member is disposed at an angle to the longitudinal axis of the first member.

In another broad form the present invention comprises:

a swivel connector for a gas delivery assembly including a face mask having a manifold, a face contacting portion which engages the face of a wearer, means to fasten the mask to a face of a wearer and an inlet which allows delivery of gas from a gas source to the inside of said manifold; the assembly further comprising a gas delivery line communicating between the gas source and said manifold; wherein the delivery line is connected to the manifold via the swivel connector which allows 360 degree axial rotation of the line about a longitudinal axis through the supply line and/or swivel movement of the line relative to the mask.

According to one embodiment, the mask comprises

a flexible manifold shell, being made of a flexible material, at least two side walls which are at least partially comprised of portions of the manifold shell;

a first mask shape forming element for distributing distortional forces to a substantial portion of one side wall that attaches to or is integral with a significant portion of that one side wall of the mask; and a second mask shape forming element for distributing distortional forces;

the manifold including an inlet which receives and retains a swivel connection means for connection of the inlet of the mask to the gas delivery pipe, the swivel connection enabling said 360 degree axial rotation and angular rotation.

More recently, masks have been designed with softer materials such as silicon which receive flexible tubes for gas delivery to the mask inlet. Since there is some flexibility in the tube, when a wearer of the mask moves, this built in flexibility will allow some mask movement before the supply line places unwanted loading on the mask thereby breaking the gas seal. Fixed moment connections as in the prior art provide a good seal but do not have sufficient flexibility or sufficient rotational capacity to allow some movements such as torsional in the case for instance when a baby is rotated. In use, loading on the mask causes lateral or longitudinal displacements transmitted via the mask shape forming elements to the manifold. The mask is sufficiently flexible to allow the whole mask shape including the flexible manifold shell and the face contacting element to be distorted into a wide range of general shapes. In attempting to accommodate movement loadings applied to the mask, the gas line strains the mask leading to potential interruption of the gas seal between face and mask. The present invention provides a swivel connection assembly which allows torsional (axial) rotations and also angular movements in radial planes.

More specifically the swivel connector allows axial loading about an axis through the line when a mask moves and rotational movement in an X axis plane and a Z axis plane. The use of a swivel connection relieves the effect of such loadings helping to maintain seal integrity.

Preferably the manifold shell, mask shape forming elements, side walls and face contacting elements and gas inlet are integrally moulded in one piece from an elastomeric material such as silicone rubber. The mask is also preferably sufficiently flexible to enable a patient to remove it or fix it in position without having to adjust any harness connection points where a harness connects to the straps of the mask. The face contacting portion of the mask typically defines an inwardly curving gas sealing surface which in use contacts the patient's face.

It is preferred that the manifold is flexible enough to collapse toward the patients nose when a moderate external force is applied to it, to allow, for example, a patient to scratch their nose without removing the mask. With the mask in situ, the manifold can be distorted onto the patient's nose without breaking the airtight seal between the face contacting element and the patients skin. This also means that when a patient turns in sleep and their mask contacts a pillow or some other object the manifold will deform rather than be pushed against the patient's face. The aforesaid geometry and consequent sealing arrangements of the known masks is further enhanced by use of at least one swivel connection assembly in the connection of the gas line to the manifold and connection of the opposite end of the line to a gas supply manifold via at least one other swivel connector.

The mask will typically be used in combination with a device for supplying gas, typically air, at a positive pressure to the patient's mouth, either through the patient's nose or through their nose and mouth. The flexible face contacting element is preferably sufficiently flexible that it substantially collapses onto the patient's face under the normal forces exerted on it by the harness and straps when in situ, in use.

The mask will preferably inflate under normal operating pressures when in situ on a patient's face, but will preferably not significantly distend in comparison with the mask's “resting” shape. The manifold shell of the flexible silicone masks will have an average wall thickness of less than 2.5 mm, preferably 1 mm to 2 mm, most preferably about 1.5 mm. In a preferred embodiment, the flexible face contacting portion has as average wall thickness of less than 1.5 mm, preferably 0.3 mm to 0.7 mm, most preferably about 0.5 mm.

In another broad form the present invention comprises:

a mask assembly for supplying gas under pressure to an airway of a human including:

a flexible manifold shell, being made of a flexible material, the manifold including means for connection to a gas delivery pipe,

at least two side walls which are at least partially comprised of portions of the manifold shell;

a first mask shape forming element for distributing distortional forces to a substantial portion of one side wall that attaches to or is integral with a significant portion of that one side wall of the mask; and

a second mask shape forming element for distributing distortional forces to a substantial portion of an other side wall that attaches to or is integral with a significant portion of that other side wall of the mask, each mask shape forming element being connected to, or being connectable to, a strap;

characterised in the assembly further comprises:

a gas delivery line communicating between the gas source and said manifold; wherein the delivery line is connected to the manifold via the swivel connector which allows 360 degree axial rotation of the line about a longitudinal axis through the supply line and/or swivel movement of the line relative to the mask.

Preferably the swivel connectors also allow angular movement relative to the longitudinal axis.

### BRIEF DESCRIPTION OF THE DRAWINGS

A specific embodiment of the present invention will now be described, according to a preferred but non limiting embodiment and with reference to the accompanying drawings, in which:

FIG. 1 illustrates a side elevation of a typical face mask including a swivel connector at the junction of a line and mask manifold;

FIG. 2 shows a perspective view of a supply line assembly including swivel connectors according to a preferred embodiment.

FIG. 3 shows according to one embodiment, a connector assembly in isolation.

FIG. 4 shows a perspective view of a connection assembly according to an alternative embodiment.

FIG. 5 shows an elevation view of the connection assembly of FIG. 4.

FIG. 6 shows a side elevation view of the connection assembly of FIG. 4.

FIG. 7 shows a top view of the connection assembly of FIG. 4.

FIG. 8 shows a long sectional view of the connection assembly of FIG. 4.

FIG. 9 shows an enlarged long sectional view of the connection assembly of FIG. 8.

FIG. 10 shows an exploded view of the connection assembly of FIG. 4 with first member separated from the second member.

### DETAILED DESCRIPTION OF PREFERRED EMBODIMENTS

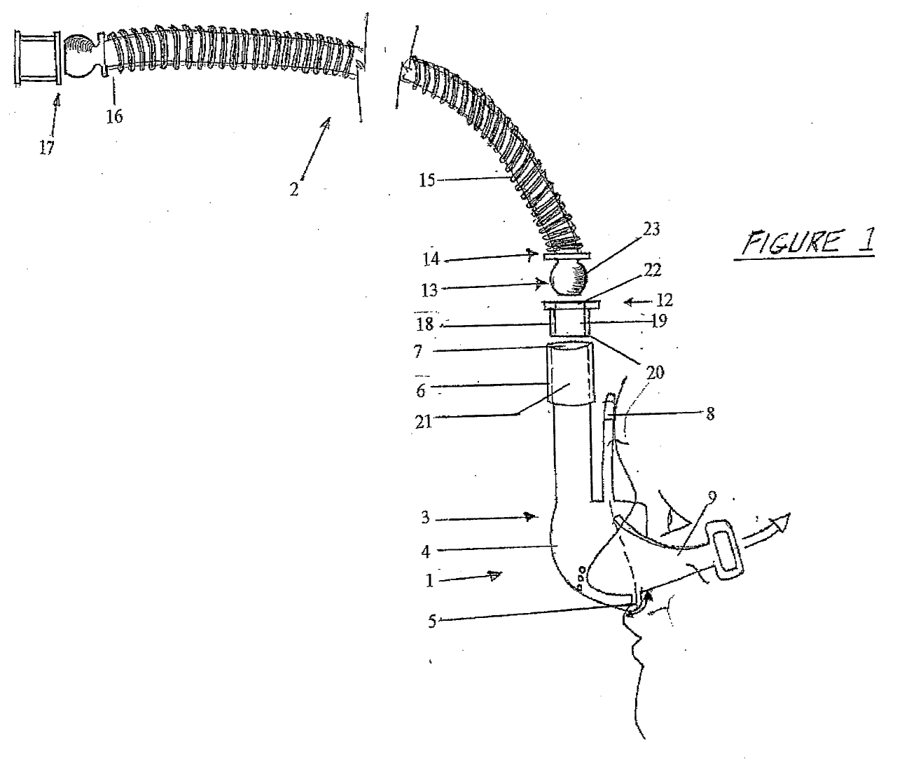

Referring to the drawings, FIG. 1 shows an elevation view of a first embodiment of a typical mask assembly 1 including swivel connector assembly 2. The mask 3 shown is designed for pressurised gas delivery to a patient's nose only.

Mask 3 is preferably integrally moulded in a single piece from a flexible elastomeric material, most preferably a medical grade silicone, however, any suitable elastomeric material may be used. Mask 3 includes a flexible central manifold 4, a flexible integral face contacting portion 5 and an annular air inlet pipe 6 extending away from the manifold 4 to a generally cylindrical outlet 7 at a distal end of the air inlet pipe 6.

Mask 3 will typically include a nasal bridge strap 8 extends away from the top of the manifold 4. Two straps 9, 10 extend away from opposite sides of the manifold in a direction which is generally perpendicular to the longitudinal axis of the nasal bridge strap 8. The wall thickness of the manifold and face contacting portion is thin enough to enable patients to stretch and compress different parts of the mask through the application of forces from the harness.

with a magnitude normally used with current conventional respirator masks. The distortional forces applied to the mask from the harness are distributed around the body of the flexible mask using a mask shape forming component, which is integral to (or may be attached to) the sidewall of the mask. The shape-forming component is designed to distribute distortional forces to a substantial portion of the mask sidewall.

Connected to outlet 7 of inlet 6 is an assembly 12 which comprises a swivel connector 13 connected to end 14 of gas supply line 15. Connected to opposite end 16 of line 15 is a second swivel connector 17. Swivel connector 13 comprises a generally cylindrical member 18 with a through passage 19. First end 20 of member 18 fits inside recess 21 of end 16 of line 15 by friction fitting. Member 18 further comprises recess 22 which receives and retains therein a profile part 23 at end 14 of supply line 15. Profile part 23 is preferably a hollow part spherical ball which fits recess 22 and allows line 15 to which profile part 23 is integrally fitted to rotate about a longitudinal axis through line 15. In addition, profile part 23 allows line 15 to move in a variety of radial arcs which add significantly to the available degrees of freedom provided by the swivel connection. A similar connection assembly will be connected at opposite end to line allowing much wider flexibility in the range of movement of the mask without compromise to gas seal integrity.

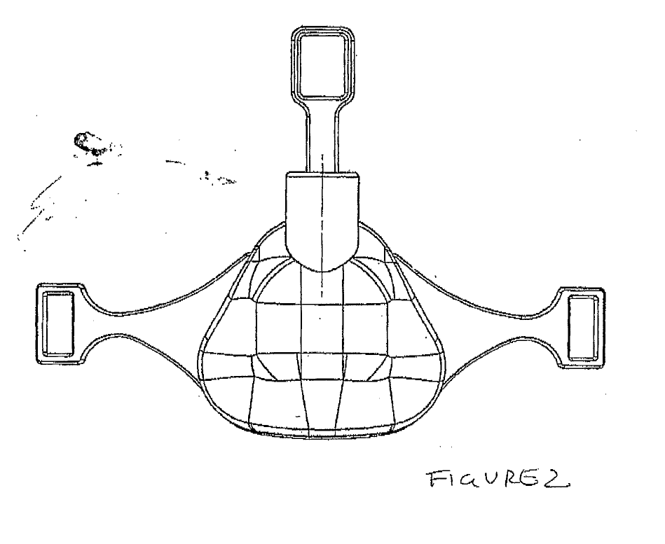

FIG. 2 shows a perspective view of a supply line assembly including swivel connectors as shown in FIG. 1 and with corresponding numbering. The patient can sleep with the mask in contact with objects such as a pillow.

FIG. 3 shows according to one embodiment, a connector assembly 30 in isolation. Connection assembly 30 is adapted for joining a gas supply line to a face mask assembly (not shown) which delivers a gas to a patient. Assembly 30 comprises a first member 31 having a first end 32 and a second end 33. Member 31 also comprises an inner wall 34 and an outer wall 35 with a through passage 36 between ends 32 and 33.

Assembly further comprises a second member 37 having a first end 38 and a second end 39. The second end 39 of member 37 is engagable with the first member 31 via the first end 32 of the first member 31. Second end 33 of the first member 31 is connectable to a corresponding connection member which is preferably located on a manifold of a face mask (not shown). The first end 38 of the second member 37 is connectable to a gas delivery line 28 which supplies gas to a patient wearing the mask.

The connection between the first and second members 31, 37 Is arranged to allow relative movement between the first and second members such that either of the first and second members are each able to rotate axially relative to the other member through a 360 degrees arc about longitudinal axes 27 through each member and to each move relative to the other member between a first disposition where the longitudinal axes of the first and second members are in alignment forming axis 27 and at least one second disposition where at least the second member 31 is disposed at an angle to the longitudinal axis 27 of the second member 37. As shown in FIG. 3 member 31 is capable of adjustment relative to axis 27 over a range of movement which disposes member 31 in a location coincident with axis 26 and over a range of location from that location to a location coincident with axis 25.

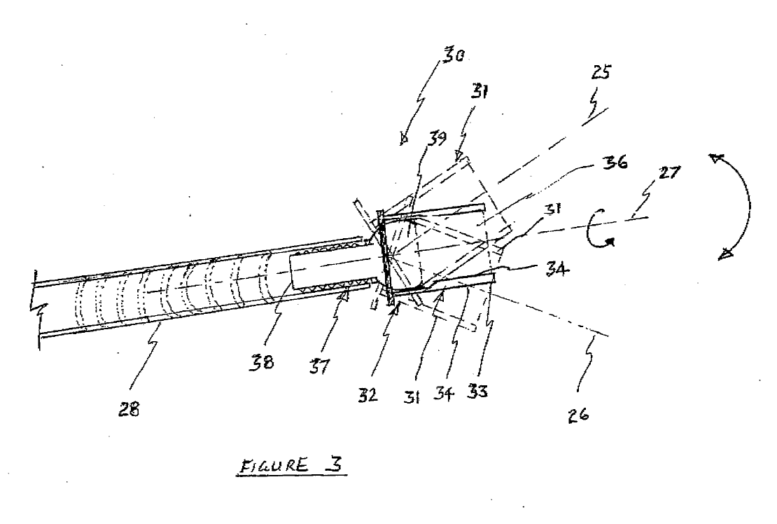

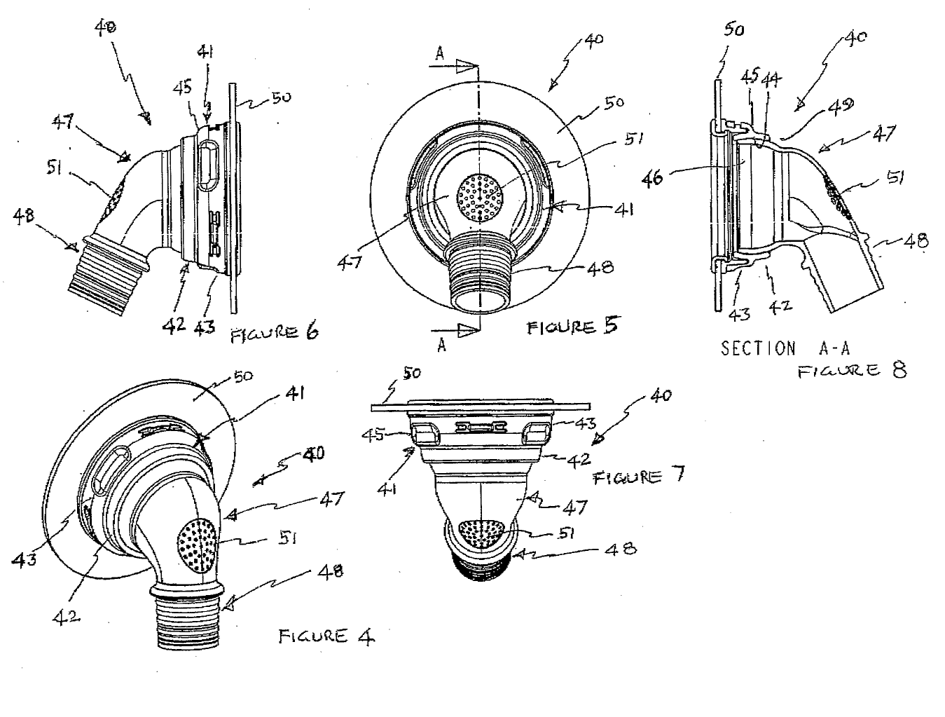

Referring to FIG. 4 there is shown a perspective view of a connection assembly 40 according to an alternative embodiment. Connection assembly 40 is adapted for joining a gas supply line to a face mask assembly (not shown) which delivers a gas to a patient. Assembly 40 comprises a first member 41 having a first end 42 and a second end 43. Member 41 also comprises an inner wall 44 and an outer wall 45 with a through passage 46 between ends 42 and 43.

Assembly further comprises a second member 47 having a first end 48 and a second flared end 49. The second end 49 of member 47 is engagable with the first member 41 via the first end 42 of the first member 41.

Second end 43 of the first member 41 is connectable to a corresponding connection member 50 which is preferably located on a manifold of a face mask (not shown). The first end 48 of the second member 47 is connectable to a gas delivery line 51 which supplies gas to a patient wearing the mask.

The connection between the first and second members 41, 47 is arranged to allow relative movement between the first and second members such that either of the first and second members are each able to rotate axially relative to the other member through a 360 degrees arc about longitudinal axes through each member and to each move relative to the other member between a first disposition where the longitudinal axes of the first and second members are in alignment and at least one second disposition where at least the second member 47 is disposed at an angle to the longitudinal axis of the first member 41. According to a preferred embodiment, first member 41 is a collar and the second member 47 is an elbow with its first end 42 of the first member 41 disposed at an angle of approximately 120 degrees to the second end 43 (best shown in FIG. 6). Elbow 47 further comprises a one way air valve 51 to enable breathing with the mask through the connection assembly 40 when gas stops.

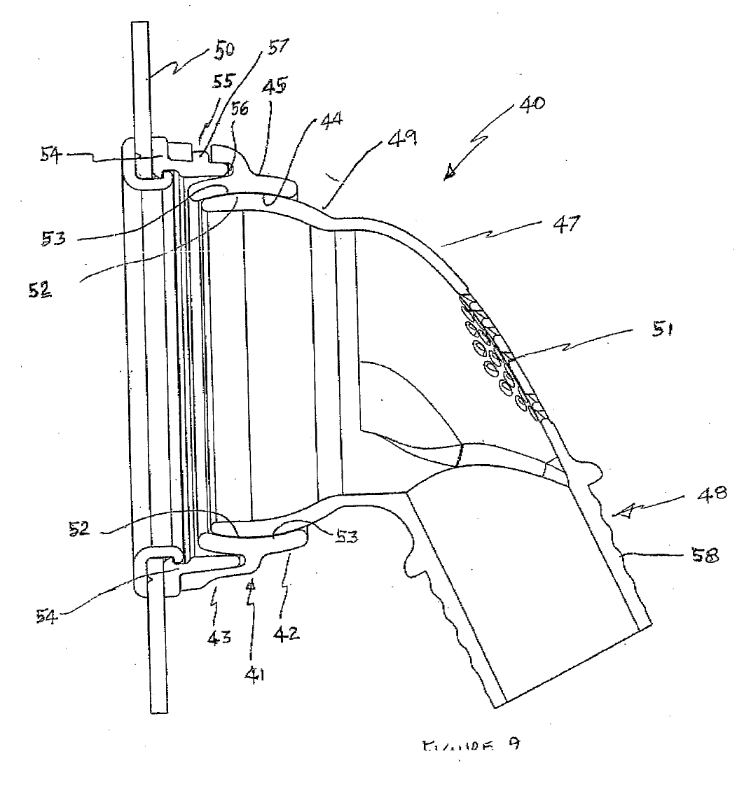

FIG. 5 shows a front elevation view of the connection assembly of FIG. 4 with corresponding numbering. FIG. 6 shows a side elevation view of the connection assembly 40 of FIG. 4 with corresponding numbering. FIG. 7 shows a top view of the connection assembly 40 of FIG. 4 with corresponding numbering. FIG. 8 shows a long sectional view of the connection assembly 40 of FIG. 4.

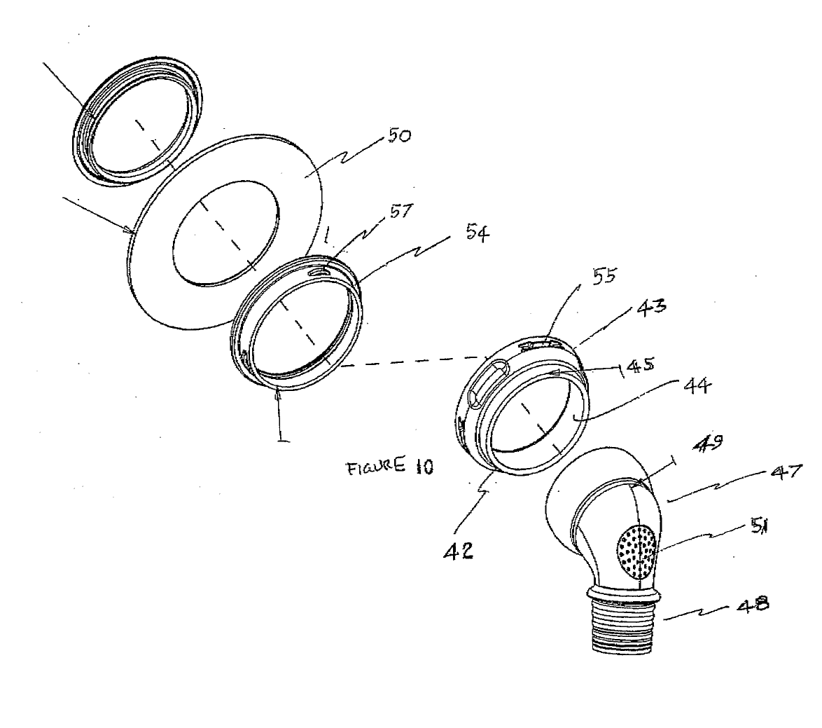

FIG. 9 shows an enlarged long sectional view of the connection assembly 40 of FIG. 8 with corresponding numbering. The manner of engagement between member 47 and first member 41 is shown in detail in FIG. 9. End 49 of elbow 47 is flared and includes a radiused contour 52 which engages with convex contour of first member 41. These contours allow member 47 to freely rotate and pivot inside member 41. Member 41 engages a flange 54 via throat 56. Flange 54 includes a series of protrusions 57 disposed about the circumference of flange 54 which engage openings 55. Rotation of member 41 relative to flange 54 allows protrusions 57 to move in and out of engagement with openings 55. This rotational engagement and disengagement between member 41 and flange 54 is relatively gentle and avoids unwanted axial loads on a mask. According to prior art masks, attachments to a manifold often require axial loading pushing on and pulling off an attachment. When a mask is in use this manner of axial action can compromise a seal as the mask is urged towards or away from the face. The assembly described in FIGS. 4-9 changes the loadings applied to remove the connection assembly which connects the gas supply to a mask. Rotational action for application and removal of the connecting assembly is slight enough to preserve scaling of the mask.

FIG. 10 shows an exploded view of the connection assembly of FIG. 4 with first member separated from the second member. The first and second members 41 and 47 are capable of swivel movement relative to each other. Member 41 releasably retains member 47. The flared end 49 of member 47 facilitates a locking engagement between members 41 and 47 but at the same time allowing a swivel motion and capacity of member 47 to rotate through 360 degrees.

The flared end 49 has an outer contoured surface over which the first end of the first member rides when the first and second members undergo relative movement. The flared region is substantially hemispherical. End 48 of member 47 includes ribbing 58 which receives a feed pipe to deliver gas to the mask.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1.-56. (canceled)

57. A connection assembly for joining a gas supply line to an article, the assembly comprising
a first member having first and second ends, inner and outer walls; and a through passage between said ends; and
a second member having first and second ends, the second end engagable with the first member via the first end of the first member, the second end of the first member connectable to the article and the first end of the second member connectable to a gas line;
wherein the connection between the first and second members is arranged to allow relative movement between the first and second members such that either of the first and second members are each able to rotate axially relative to the other member through a 360 degrees arc about a longitudinal axes through one of the members and to each move relative to the other member between a first disposition where longitudinal axes of the first and second members are in alignment and at least one second disposition where at least the second member is disposed at an angle to a longitudinal axis of the first member.

58. The connection assembly according to claim 57, wherein the first and second members are capable of swivel movement relative to each other.

59. The connection assembly according to claim 58, wherein the first member releasably retains the second member.

60. The connection assembly according to claim 59, wherein the second end of the second member comprises a flared portion.

61. The connection assembly according to claim 60, wherein the flared portion has an outer contoured surface over which the first end of the first member rides when the first and second members undergo relative movement.

62. The connection assembly according to claim 61, wherein the first member is generally cylindrical.

63. The connection assembly according to claim 62, wherein the flared region is substantially hemispherical.

64. The connection assembly according to claim 63, wherein the inner wall of the first member has a region of a first thickness at the first end and a region of a second thickness at the second end.

65. The connection assembly according to claim 64, wherein the inner wall has a transition region between the region of first thickness and the region of second thickness.

66. The connection assembly according to claim 65, wherein the transition region terminates in a shoulder

67. The connection assembly according to claim 66, wherein the shoulder on the inner wall of the first member is located approximately midway between the first and second ends of the first member.

68. The connection assembly according to claim 67, wherein the outer wall of the first member includes a collar.

69. The connection assembly according to claim 68, wherein the article to which the second end of the first member is attached is a face mask.

70. The connection assembly according to claim 69, wherein the flared portion of the second end of the second member terminates approximately midway between the first and second ends of the second member.

71. The connection assembly according to claim 70, wherein, the flared region morphs into a connecting member at an interface.

72. The connection assembly according to claim 71, wherein the interface engages a circumference at the first end of the first member.

73. The connection assembly according to claim 72, wherein the interface rides along the circumference of the first member when the second member swivels to its maximum extent.

74. The connection assembly according to claim 73, wherein, when the second member swivels relative to the first member, the second member defines a conical path.

75. The connection assembly according to claim 74, wherein the interface of the second member includes a flange which provides an abutment for an end of the pipe.

76. The connection assembly according to claim 75, wherein the connecting member on the second member is ribbed to facilitate engagement of the connector with the gas supply pipe.

77. The connection assembly according to claim 76, wherein the collar at the first end of the first member provides an abutment for a corresponding connecting part of a mask.

78. The connection assembly according to claim 77, wherein the face mask has a manifold, a face contacting portion which engages the face of a wearer, means to fasten the mask to a face of a wearer and an inlet to the manifold which allows delivery of gas from a gas source to the inside of said manifold; wherein, the delivery line is connected to the manifold via the connection assembly which allows 360 degree axial rotation and/or swivel movement of the line relative to the mask.

79. A swivel connector for a gas delivery assembly comprising:
a face mask including:
a manifold;
a face contacting portion which engages the face of a wearer;
means to fasten the mask to a face of a wearer; and
an inlet which allows delivery of gas from a gas source to the inside of said manifold; and
a gas delivery line communicating between a gas source and said manifold;
wherein the delivery line is connected to the manifold via the swivel connector which allows 360 degree axial rotation of the delivery line about a longitudinal axis through the supply line and/or swivel movement of the line relative to the mask.

80. The swivel connector according to claim 79, further comprising:
a first member having first and second ends, inner and outer walls; and a through passage between said ends; and
a second member having first and second ends, the second end engagable with the first member via the first end of the first member, the second end of the first member connectable to the article and the first end of the second member connectable to a gas line;
wherein the connection between the first and second members is arranged to allow relative movement between the first and second members such that either of the first and second members are each able to rotate axially relative to the other member through a 360 degrees arc about longitudinal axes through each member and to each move relative to the other member between a first disposition where the longitudinal axes of the first and second members are in alignment and at least one second disposition where at least the second member is disposed at an angle to the longitudinal axis of the first member;
wherein the inner wall of the first member has a region of a first thickness at the first end and a region of a second thickness at the second end; and
wherein the inner wall has a transition region between the region of first thickness and the region of second thickness.

81. A mask assembly for supplying gas under pressure to an airway of a human comprising:
a flexible manifold shell, being made of a flexible material, the manifold including means for connection to a gas delivery pipe,
at least two side walls which are at least partially comprised of portions of the manifold shell;
a first mask shape forming element for distributing distortional forces to a substantial portion of one side wall that attaches to or is integral with a significant portion of that one side wall of the mask; and
a second mask shape forming element for distributing distortional forces to a substantial portion of an other side wall that attaches to or is integral with a significant portion of that other side wall of the mask, each mask shape forming element being connected to, or being connectable to, a strap;
characterised in the assembly further comprises a gas delivery line communicating between the gas source and said manifold; wherein the delivery line is connected to the manifold via a swivel connector which allows 360 degree axial rotation of the line about a longitudinal axis through the supply line and/or swivel movement of the line relative to the mask.
